(19) United States
(12) Patent Application Publication
(10) Pub. No.: US 2022/0267224 A1
(43) Pub. Date: Aug. 25, 2022

(54) COMPOSITION TO ENHANCE NUTRIENT CONTENT IN PLANTS

(71) Applicant: Venkat Reddy CHINTHALA, Secunderabad (IN)

(72) Inventor: Venkat Reddy CHINTHALA, Secunderabad (IN)

(21) Appl. No.: 17/631,515

(22) PCT Filed: Aug. 1, 2020
(86) PCT No.: PCT/IB2020/057299

§ 371 Date: Jan. 31, 2022

(30) Foreign Application Priority Data
Aug. 2, 2019 (IN) 201941031393

(51) Int. Cl. C05F 11/00; C05G 5/23; A01C 23/04; A01C 1/06

(52) U.S. Cl. CPC C05F 11/00; C05G 5/23; A01C 23/047; A01C 1/06

(57) ABSTRACT

The current disclosure relates to a chemical-free composition that increases the nutritive value of crops, by increasing vitamin levels in the crop produce. The composition disclosed in the current invention also increases crop yield. The composition does not contain any chemicals and can increase vitamin levels in the crop produce by non-transgenic means, which can help to alleviate deficiency diseases due to malnutrition in an inexpensive and sustainable manner.

### FIELD OF THE INVENTION

The invention relates to the field of plant sciences and a chemical-free fertilizer composition which leads to an increase in the nutrient content of crop plants, and increases the crop yield. The invention specifically relates to a nutrient enhancing composition which increases vitamin D content in cereal crops when applied during irrigation to the plants.

### BACKGROUND OF THE INVENTION

Micronutrient malnutrition is a widespread problem throughout the world, and it has both health and economic consequences. Poor countries, developing or even developed countries, may have poor diets due to reduced intake of many micronutrients, because of the large dependence of the food industry on salt, sugar, vegetable fats and refined cereals, all of which are poor sources of vitamins and minerals. In poor countries, this deficiency is exacerbated by systemic infections and parasitic diseases that reduce nutrient absorption and biological utilization. The focus of nutritional sufficiency has shifted from protein sufficiency and energy sufficiency to micronutrient sufficiency.

Various chemical-based products are known to be used for a long time, to enhance soil fertility, with an aim to obtaining more produce and for combating plant pests and diseases. With more emphasis on higher quality farm produce, several techniques to improve nutritive values are also being explored and used. Increasing nutritive value of crops can also help combat prevalence of deficiency diseases, such as Vitamin A, D and C deficiency in an inexpensive and easy manner.

Vitamin D, which includes ergocalciferol (vitamin D2) and cholecalciferol (vitamin D3) is a fat soluble vitamin and is required in sufficient amounts for calcium absorption and healthy bone development. Recent research has also implicated the role of vitamin D in regulating immune health and cardiac function.

A minimum of 1000 IU per day of vitamin D3 is recommended for healthy adults, and 400 IU per day of vitamin D3 taken with food for children. In some cases, higher doses of vitamin D may be necessary for those patients with vitamin D deficiency or certain health conditions. Vitamin D is found in very few plant based sources, such as mushrooms. But most of the plants that form a staple diet of humans, including cereals such as wheat, rice, oats, corn, do not contain any vitamin D. Vitamin D3 (cholecalciferol) is produced in the skin on exposure to sunlight. Vitamin D3 is derived from 7-dehydrocholesterol by ultraviolet irradiation of the skin. Sun exposure alone ought to suffice to attain vitamin D sufficiency. However, even in tropical countries like India, despite plentiful sunshine, vitamin D deficiency prevails in as high as 70%-100% of ostensibly healthy individuals, due to several socioeconomic and cultural constraints.

Many chemical fertilizers and pesticides are currently being used and being developed to increase soil fertility, decrease pest attacks and increase crop yield. These chemical fertilizers and pesticides have many disadvantages, including leading to food grains that are grown using chemical fertilisers and pesticides having high chemical content, which is harmful for humans and animals on continuous consumption.

Moreover, most of these chemical based fertilizer compositions are not effective in enhancing the vitamin levels of plants, specifically vitamin D. Fortification of widely consumed staple foods is one of simple methods to combat micronutrient deficiencies for both poor and wealthy societies. If the fortification can be done by non-artificial means, by growing plants with higher nutritive content, it would reduce the processing of the foods, and also provide a stable source of micronutrients such as vitamins and minerals.

As of now, there are no reports of compositions that, on application during plant growth, can enhance the vitamin D content in non-genetically modified crops. There are a few green fertilizers or organic fertilizer compositions reported but these do not enhance Vitamin D levels in plants. As of now, the genetic modification of crops is the major way to increase nutrient content in plants, such as golden rice that has increased Vitamin A content. A chemical free nutrient enhancing composition that can increase the vitamin content in crop plants is highly desirable, since consumption of such crop produce can alleviate vitamin deficiency.

The present invention puts forth a new composition based on non-chemical, natural plant based extracts to produce crop plants with high Vitamin D content, without genetic modification or application of chemicals. The current invention discloses method and composition to produce crop plants, more specifically cereals, with high vitamin D content, consumption of which can contribute to alleviation of vitamin D deficiency which is rampant in developing as well as developed countries. Application of this composition also results in higher yields of cereal plants.

### SUMMARY

The current invention relates to a composition to increase Vitamin D content of crop plants, upon its application to plants during irrigation. The invention discloses eco-friendly, sustainable and low-cost compositions and method for increasing Vitamin D content and yield in plants, without genetic modification or chemical treatments.

One embodiment of the current invention is a nutrient enhancing composition comprising carrot extract, maize flour and sweet potato extract, wherein the composition increases vitamin D content in plants when applied during irrigation of crop plants.

In one embodiment, the carrot extract, sweet potato extract and maize flour are present at a concentration of 2 to 5 kg per 200 litres of irrigation water. In one embodiment, the composition further comprises beet root extract at 2-5 kg per 200 litres of irrigation water. In one embodiment, the carrot extract, beetroot extract and sweet potato extract are made by cooking and blending carrots, beetroots and sweet potatoes respectively.

In one embodiment, the extract is made by cooking and blending raw carrots, beet root or sweet potatoes at a weight that is half of the final extract required. In one embodiment, the maize flour is made by grinding corn kernels. In one embodiment, the carrot, sweet potato and beet root extract comprise 1:1 weight ratio of the respective vegetables to water.

In one embodiment, carrot powder, beet root powder or sweet potato powder can be used instead of the respective extracts. In one embodiment, the carrot powder is made by cutting carrots into pieces, drying, and grinding into powder. In one embodiment, 1 kg of raw carrots, beet roots, and sweet potatoes gives 4 to 5 kg of respective vegetable powders.

In one embodiment, the composition disclosed herein is applied to the crop plants at least once between flowering stage and harvest. In one embodiment, the composition is applied to the crop plants at least twice between flowering and harvest. In one embodiment, the composition is applied at least once before flowering time. In one embodiment, the composition is applied during irrigation by spray irrigation. In one embodiment, the composition is applied during irrigation by rain pipe irrigation. In one embodiment, the composition further includes subsoil decant. In one embodiment, the composition further comprises top soil decant.

In one embodiment, application of the composition also increases yield of crop plants. In one embodiment, the crop plants are cereal plants.

One embodiment of the current invention is a method of increasing Vitamin D content in crop plants, wherein the method comprises the step of applying at least once a nutrient enhancing composition comprising carrot extract, maize flour and sweet potato extract during irrigation of crop plants. In one embodiment, the composition for the above method further comprises beet root extract.

In one embodiment, the at least one application of the composition disclosed herein is done between flowering time and harvest of crop plants.

In one embodiment, the carrot extract, sweet potato extract and maize flour are present at a concentration of 2 to 5 kg per 200 litres of irrigation water. In one embodiment, the method further comprises at least one application of the composition before flowering. In one embodiment, the method further comprises soaking the seeds of the crop plant in the composition before sowing. One embodiment of the invention is the crop plants produced by the method disclosed herein. One embodiment of the invention is the grains of the crop plants produced by the method disclosed herein.

In one embodiment, the crop plants are cereal plants. In one embodiment, the cereal plants are wheat or rice plants. In one embodiment, the Vitamin D content in the cereal plants is undetectable without application of the composition disclosed herein.

### DETAILED DESCRIPTION

The current invention describes a novel, eco-friendly composition which can be applied to crop plants to increase the nutritive content and/or yield of plants. The invention discloses a composition, and a method of using the composition for crop plants to enhance their nutrient content, particularly, vitamin D content.

### Definitions

The use of numerical values in the various ranges specified in this application, unless expressly indicated otherwise, are stated as approximations and the invention should not be restricted exactly by the ranges given herein. A person of ordinary skill in the art will understand that the invention can be practiced even when there is some variation from the numerical ranges given herein.

Nutritive value is an indication of the contribution of a food to the nutrient content of the diet. This value depends on the quantity of a food which is digested and absorbed and the amounts of the essential nutrients (protein, fat, carbohydrate, minerals, vitamins) which it contains.

As used herein, the terms “spray irrigation”, “rain hose irrigation” and “rain pipe irrigation (RPI)” are used interchangeably, and refer to irrigation, or application of the organic composition disclosed herein by a water spray system.

The water spray system may consist of a flat flexible plastic hose with 40 mm WT and Spray width 8 to 10 feet @ pressure rate of 1.00 kg/cm², Flow Rate (@ 1.00 kg/cm²) and at flow rate 350˜550 1 ph (liters per hour) to irrigate crops.

As used herein the term “biologically effective amount” refers to the amount of the composition disclosed herein, that is required to produce the desired effect on a plant, plant propagating material and/or plant part, or plant produce, such as, for example, germination improvement, growth improvement, yield improvement, pest control, disease control, increase in vitamin levels in crop produce, decrease in gluten levels in wheat grains, increase in protein content in cereal crop produce and decrease in carbohydrate levels in cereal crop produce.

Effective amounts of the composition will depend on several factors, including treatment method, plant species, propagating material type and environmental conditions.

As used herein, the term “enhancing vitamin D in crop plants” would refer to enhancing Vitamin D content in any or all parts of the plant. More specifically it refers to increasing Vitamin D content in the edible portions of the crop plant. Examples of edible portions of the plant include, but are not limited to, roots, seeds, stems, leaves and fruits.

The crop plants may be any plant, which may be cultivated. In one embodiment, the crop plant is a cereal. In one embodiment, application of the composition disclosed herein increases Vitamin D content in cereal crops.

Examples of cereal crops includes, but are not limited to, wheat, maize, rice, barley, oats, rye and sorghum. In one embodiment, the application of the composition disclosed herein increases Vitamin D content in, wheat, maize, rice, barley, oats, rye or sorghum. In one embodiment, the application of the composition disclosed herein increases Vitamin D content in wheat and/or rice. In one embodiment, application of the composition disclosed herein increases Vitamin D content in cereal crop grains. In one embodiment, application of the composition disclosed herein increases Vitamin D content in wheat and/or rice grains. In one embodiment, the flour made from the grains of the cereal crop which has been treated with the composition disclosed herein, has increased Vitamin D content.

In one embodiment, consumption of produce from the crop plants produced by application of the composition disclosed herein can alleviate vitamin D deficiency.

Foliage as defined in the present application includes all aerial plant organs, for example, the leaves, stems, flowers and fruit.

As used herein, the term “top soil” refers to soil till depth of 3 inches of cultivable plot of red, loamy soil and dried till no moisture levels under shade or partially sundried

As used herein, the term “sub soil” refers to soil excavated up to depth of 4 feet using excavator or manually from cultivable plot of red, loamy soil and dried till no moisture levels under shade or partially sundried

As used herein, the term “plot” refers to farmers' agricultural land cultivable with regular farming during the entire or part of the year with seasonal cereals, vegetables (homestead crops like tomatoes, okra, eggplant etc) or perennial fruit crops (like grapes, guava, papaya etc).

The term “yield” as defined herein refers to the return of crop material per unit area obtained after harvesting a plant crop. An increase in crop yield refers to an increase in crop yield relative to an untreated control treatment. Crop materials include, but are not limited to, seeds, fruits, roots, tubers, leaves and types of crop biomass. Descriptions of field-plot techniques used to evaluate crop yield may be found in W. R. Fehr, Principles of Cultivar Development, McGraw-Hill, Inc., New York, N.Y., 1987, pp. 261-286 and references incorporated therein.

As used herein, the term ‘decant’ refers to decanted water from topsoil or sub soil soaked and stirred vigorously in water.

In one embodiment, the decant may be made by putting 25-35 kg of soil/400 liters of water for at least one hour. In one embodiment, the decant may be prepared by adding 30 kg of soil in 400 liters of water, and letting it settle for 1-2 hours.

In one embodiment, decanted water is taken after 15-30 minutes after stirring, which is done for 10-15 minutes, and then filtered through fine mesh (200 ug) to avoid blocking of holes in rain hose.

As used herein, the term ‘wheat sprouts’ refers to wheat grains soaked for sufficient time so that they start germinating, In one embodiment, wheat sprouts are made by soaking for 10-14 hours, and then germinated on moisture soaked muslin cloth or tissue paper rolls.

In one embodiment, wheat sprouts are made by soaking for 12 hours and then germinated on moisture-soaked muslin cloth or tissue paper rolls; sprouts dried and ground as paste.

As used herein, the term ‘sour curd’ refers to 3-6 days old yoghurt kept at ambient temperature. Sweet potato, carrot, tomato extract refers to extract made from the respective vegetable/fruit by cooking, and blending them. In one embodiment, the extract is made by cooking and blending raw carrots, beet root or sweet potatoes at a weight that is half of the final extract required.

In one embodiment, the maize flour is made by grinding corn kernels.

In one embodiment, carrot powder, beet root powder or sweet potato powder is used instead of the respective extracts. In one embodiment, the carrot powder is made by cutting carrots into pieces, drying, and grinding into powder. In one embodiment, 1 kg of raw carrot gives 4 to 5 kg of carrot powder

In one embodiment, they are cut into 2-4″ pieces, sun-dried and ground into powder.

### Embodiments

The current invention relates to a composition to increase Vitamin D content of crop plants, upon its application to plants during irrigation. The invention discloses compositions and method for increasing Vitamin D content and yield in plants, without genetic modification or chemical treatments.

One embodiment of the current invention is a nutrient enhancing composition comprising carrot extract, maize flour and sweet potato extract, wherein the composition increases vitamin D content in plants when applied during irrigation of crop plants. In one embodiment, the carrot extract, sweet potato extract and maize flour are present at a concentration of 2 to 5 kg per 200 litres of irrigation water. In one embodiment, the carrot extract and sweet potato extract are made by cooking and blending carrots and sweet potatoes respectively. In one embodiment, the raw carrots, beet roots or sweet potatoes are cooked till they are soft for making the extract. In one embodiment, they are cooked/boiled for 30 minutes to 1.5 hours to make them soft. In one embodiment, the maize flour is produced by grinding dried corn kernels.

In one embodiment, the composition is applied to the crop plants at least once between flowering stage and harvest. In one embodiment, the composition is applied to the crop plants at least twice between flowering and harvest. In one embodiment, the composition is applied at least once before flowering time.

In one embodiment, the composition is applied during irrigation by spray irrigation.

In one embodiment, the composition further includes subsoil decant. In one embodiment, at least 5 kg of subsoil is added to 200 litres of water to make the subsoil decant.

In one embodiment, the composition further comprises top soil decant.

In one embodiment, application of the composition also increases yield of cop plants.

In one embodiment, the crop plants are cereal plants.

One embodiment of the current invention is a method of increasing Vitamin D content in crop plants, wherein the method comprises the step of applying at least once a nutrient enhancing composition comprising carrot extract, maize flour and sweet potato extract during irrigation of crop plants.

In one embodiment, the at least one application is done between flowering time and harvest of crop plants. In one embodiment, the carrot extract, sweet potato extract and maize flour are present at a concentration of 2 to 5 kg per 1000 litres of irrigation water. In one embodiment, the method further comprises at least one application of the composition before flowering.

In one embodiment, the method further comprises soaking the seeds of the crop plant in the composition before sowing. One embodiment of the invention is the crop plants produced by the method disclosed herein.

One embodiment of the invention is the grains of the crop plants produced by the method disclosed herein. In one embodiment, the crop plants are cereal plants. In one embodiment, the cereal plants are wheat or rice plants. In one embodiment, the Vitamin D content in the cereal plants is undetectable without application of the composition disclosed herein.

One embodiment of the invention is a composition comprising components selected from the group consisting of topsoil decant, subsoil decant, wheat sprouts, soya flour, sour curd, rock dust, jaggery, wheat flour, maize flour, carrot extract, tomato extract, beetroot extract and sweet potato extract.

One embodiment of the invention is a composition comprising components selected from the group consisting of sweet potato extract, carrot extract, maize flour, beet root extract and tomato extract.

One embodiment of the invention is a composition comprising components selected from the group consisting of sweet potato powder, carrot powder, maize flour, and beet root powder.

In one embodiment of the invention the composition is suspended in water.

In one embodiment of the invention the sub soil is taken from a depth of 4-6 feet of the plot. One embodiment of the invention is a composition comprising decant of top soil, decant of sub soil and sour curd. In one embodiment of the invention the agricultural composition is suspended in water.

In one embodiment, the composition further comprises sub soil. In one embodiment, the composition further comprises top soil.

One embodiment of the invention is a composition comprising decant of sub soil, carrot extract, tomato extract and maize flour. In one embodiment the carrots are in a boiled and mashed (blended) form. In one embodiment the tomatoes are in a raw and ground form.

An embodiment of the invention is a composition to enhance nutrient content of plants, wherein the composition comprises sweet potato and carrot extract. In an embodiment of the invention the carrot, sweet potato, and/or beetroot are used in a boiled and mashed form. In one embodiment of the invention, sweet potatoes, carrots, and/or beet roots are used in a dried powder form. In one embodiment of the invention, the composition further comprises of maize flour. In one embodiment of the invention, the composition comprises of subsoil. In one embodiment of the invention, the subsoil is suspended in water. In one embodiment of the invention the subsoil is soaked in water before preparing the subsoil decant. In one embodiment of the invention, the top layer of water was decanted from the soaked soil.

In one embodiment of the invention, the composition disclosed herein further comprises sour curd.

In one embodiment of the invention, the agricultural composition further comprises of yellow soy flour.

One embodiment of the invention is a method of applying the composition to enhance the nutrient content of plants, the composition comprising components selected from the group consisting of topsoil decant, subsoil decant, wheat sprouts, soya flour, sour curd, rock dust, jaggery, wheat flour, maize flour, carrot extract, tomato extract, and sweet potato extract.

In one embodiment of the invention the method of applying the agricultural composition of the invention comprises the steps of soaking the seeds of a crop in the composition of the invention.

In one embodiment of the invention, the seeds are soaked in a composition comprising dry sweet potato powder and/or extract, carrot powder and/or extract and tomato powder and/or extract. In one embodiment, the composition comprising dry sweet potato powder, carrot powder and tomato powder was suspended in water. In one embodiment the seeds were soaked for 9-15 hours in the nutrient enhancing composition disclosed herein. In one embodiment the seeds of wheat crop were soaked in the agricultural composition of the invention.

In one embodiment, the composition disclosed herein is applied to foliage. In other embodiments, the composition is applied to soil either prior to or following sowing.

In one embodiment of the invention the method of applying the composition of the invention comprises the step of sowing the seeds by manual sprinkling or any other method of sowing.

In one embodiment of the invention, the method of applying the composition of the invention comprises the step of application of the agricultural composition to the soil. In one embodiment of the invention, the agricultural composition of the invention is applied with 1 kg/cm² pressure (which is equivalent to 14.2 psi approximately).

In one embodiment of the invention, the method of applying the composition comprises application through rain pipe irrigation.

In one embodiment of the invention, the method of applying the composition comprises the step of suspending the composition in 200 liters of water before application to all beds. In one embodiment, the composition comprises 2-5 kg of carrot extract, sweet potato extract and maize flour. In one embodiment, it further comprises 2-5 kg of beet root extract. In one embodiment, it further comprises 2-5 kg of tomato extract.

In one embodiment of the invention, the composition of the invention enhances vitamin D levels by at least 10 fold in the crop produce from the crop to which it is applied as a fertilizer. In one embodiment of the invention, the composition disclosed herein enhances vitamin D levels by at least 100 fold in the crop produce from the crop to which it is applied as a fertilizer. In one embodiment of the invention, the composition of the invention enhances vitamin D levels by at least 500 fold in the crop produce from the crop to which it is applied as a fertilizer. In one embodiment, the fold increase in Vitamin D level in the cereral plants by application of the composition described herein is difficult to estimate because the control values are zero or not detectable.

In one embodiment, the composition enhances the content of both vitamin D2 and D3 in the crops.

In one embodiment, the composition enhances the content of vitamin D2 in the crops. In one embodiment, the composition enhances the content of vitamin D3 in the crops.

In one embodiment, applying the composition disclosed herein leads to increase in vitamin D levels in the crop produce.

In one embodiment, the composition disclosed herein increases the yield of the crop it is applied to as a fertilizer. In one embodiment, the yield increases by at least 2%, 3%, 4%, 5%, 6%, 7% or 8% by application of the composition disclosed herein to crop plants. In one embodiment, the yield increases by at least 2%, 3%, 4%, 5%, 6%, 7% or 8% by application of the composition disclosed herein to cereal plants.

In one embodiment, the yield increases by at least 2%, 3%, 4%, 5%, 6%, 7% or 8% by application of the composition disclosed herein to rice plants. In one embodiment, the yield increases by at least 2%, 3%, 4%, 5%, 6%, 7% or 8% by application of the composition disclosed herein to wheat plants.

In one embodiment, the composition disclosed herein can be used to increase the quality and quantity of any crop. Examples of such crops include, but are not limited to, wheat, rice, corn, grapes, millets, soybean, peanuts, potato, barley, rye, oat, sorghum, cotton, soybean, peanut, rapeseed, and sugar cane.

Some other examples of crops that the composition disclosed herein can be used on, include, but are not limited to, vegetables such as Solanaceaeous vegetables (eggplant, tomato, green pepper, hot pepper, potato, etc.), Cucurbitaceous vegetables (cucumber, pumpkin, zucchini, watermelon, melon, squash, etc.), Crucifeous vegetables (Japanese radish, turnip, horseradish, kohlrabi, Chinese cabbage, cabbage, brown mustard, broccoli, cauliflower, etc.), Asteraceous vegetables (burdock, garland chrysanthemum, artichoke, lettuce, etc.), Liliaceous vegetables (Welsh onion, onion, garlic, asparagus etc.), Umbelliferous vegetables (carrot, parsley, celery, parsnip, etc.), Chenopodiaceous vegetables (spinach, Swiss chard, etc.), Labiataceous vegetables (Japanese basil, mint, basil, etc.), strawberry, sweet potato, yam, and aroid.

In one embodiment, the composition disclosed herein can also be used in combination with other fungicides, insecticides, acaricides, nematicides, herbicides, plant growth regulator, fertilizers or soil improving agents in admixture, or simultaneously without mixing.

In one embodiment, the composition disclosed herein leads to reduced pest infestation of the crop plants. Examples of plant diseases on which the composition disclosed herein may exert a control effect includes, but are not limited to, the following diseases.

Rice diseases: Rice is attacked by numerous diseases, caused by fungi, bacteria, viruses, and nematodes. Some of the rice diseases are Blast, sheath blight, brown spot, narrow leaf brown spot, bacterial leaf blight, bacterial streak, Tungro, Stripe disease, dwarf disease, grassy stunt disease. Some of the pests that attack rice are stem borers, leafhoppers such as brown plant hopper, green rice leafhopper, and gall Midge (Khush, G. S. (1977). Disease and Insect Resistance in Rice. Advances in Agronomy, 265-341. doi:10.1016/s0065-2113(08)60221-7).

Wheat diseases: Erysiphe graminis, Fusarium sp. (F. graminearum, F. avenacerum, F. culmorum, Microdochium nivale), Puccinia sp. (P. striiformis, P. graminis, P. recondita, P. triticina), Micronectriella nivale, Typhula sp., Ustilago tritici, Tilletia caries, Pseudocercosporella herpotrichoides, Mycosphaerella graminicola, Stagonospora nodorum, Pyrenophora tritici-repentis.

The composition disclosed herein may be used in several ways to combat plant infections and/or diseases. The method of controlling a plant disease by using the composition disclosed herein may be carried out by plant application, or by soil application, with an effective amount of the composition. Examples of such plants include plant stems and leaves, plant seeds and plant bulbs. The composition may be applied to any or all parts of the plant for controlling disease or pest attack. The plant application may include foliar spray, stem application, root application and seed application, or applying on the plant to decrease disease and pest attack incidence.

Examples of such a stem and leaf treatment include a method of treating the surface of a cultivated plant by spraying on stems and leaves and spraying on the stem/trunk of the plant. Examples of such a soil treatment include spraying on a soil, mixing with a soil and drug solution injection into a soil.

### Examples

### Example 1: Treatment of Wheat to Enhance Vitamin D Content, Season 1 (2018-2019)

Wheat, variety Khudrat 17, Season: Rabi (November to March), 2018-2019, 2200 square metres plot, location 1

A plot of 2200 sq metre was used to study organic treatments to increase nutrient content and/or increase yield.

Each spray of the whole plot of 2200 sq metre was with 1000 litres of the composition given (each drum/barrel is 200 litres). Two sprays of the composition disclosed in the tables given below were done before flowering stage.

Post flowering till harvest: one spray at least once a week were done. Two sprays per week were done between flowering and harvest.

The sprays were initially done manually. Later 45 to 50 DAS, all the spraying was done by rain pipe irrigation (RPI).

Plot/Bed Preparation was done by ploughing six times with rotovator mounted on tractor; depth of blade into soil was 6 to 8″ 4 feet (W)×170 ft (L) beds were prepared 3 days prior to sowing, each bed was watered with rain pipe irrigation. Pipe Outer diameter was about 60 mm. Spray width was 8-12 mtr @ 1.00 kg/cm². There was no clogging observed during this irrigation method. Objective to allow weeds to germinate

Seed preparation: Seeds of wheat variety (Khudrat 17) were soaked overnight in the composition given below. The seeds were soaked in a composition comprising dried Sweet potato powder (200 g)+Carrot powder (200 g)+tomato powder (100 g) in 10 litres of water. wheat seeds (20 kg) were soaked 10-12 hours or overnight. Suitable controls were done by soaking in only water.

Sowing was done directly by manual sprinkling of the seeds on beds.

Gentle Ploughing was done along with sowing, with an objective to remove the three-day old germinated weeds and turn in the sown wheat seeds into the soil. With this, the weeds could be uprooted and led to reduced labour engagement. sowing was thicker than normal rate of seed sowing of wheat to ensure more plant population and afford no scope for weeds to grow. Irrigation schedule was at 7 to 10 days interval.

The treatment with different extracts to enhance nutrient content in wheat was done as given below. Subsoil, wherever used, was Subsoil @ at 4-6 feet depth from the same plot was soaked with water; decanted top layer of water used in the formulation. Topsoil, wherever used, was from the same plot. Rockdust, wherever used, was soaked with water; decanted top layer of water from soil soaked in 200 litres water used in the formulation. Gypsum, wherever used, was soaked with water; decanted top layer of water from gypsum soaked in 200 litres water used in the formulation. All sprays were done after 45-50 DAS DAS through rain pipe irrigation with 1 kg/cm² pressure.

A. composition A; at 20 DAS; This contains

| | | |
|---|---|---|
| Decant of Sub Soil | 40 kg in 200 litres of | Mixed all three |
| | water | components in 400 |
| Wheat sprouts | 2 kg | litres of water and |
| Sova flour | 4 kg | applied in all beds |

B. composition B; Applied at 26 DAS; This contains

| | | |
|---|---|---|
| Decant of Topsoil* | 30 kg in 200 litres of | Mixed all three |
| | water | components in 400 |
| Decant of Sub soil | 30 kg in 200 litres of | litres of water and |
| | water | applied in all beds |
| Sour Yoghurt/Curd | 4 kgs | |

C. composition C; at 34 DAS; This contains

| Decant of Sub Soil | 30 kg in 200 litres of | | Mixed all components |
|---|---|---|---|
| | water | | in 400 litres of water |
| Rock dust | 20 | Kg | and applied in all beds |
| Jaggery | 4 | kg | |
| Wheat flour | 2 | kg | |
| Soy flour | 2 | kg | |
| Sour Curd (Yoghurt) | 4 | kg | |

D. composition D; at 38 DAS; This contains

| | | |
|---|---|---|
| Top Soil* | 50 kgs in 200 litres of | Mixed all components |
| | water | in and applied in all |
| Wheat flour | 6 Kgs | beds |
| Maize flour | 4 kgs | |

E. composition E; at 45 DAS; This contains

| | | |
|---|---|---|
| Decant of topsoil | 40 kg in 200 litres of | Mixed all components |
| | water | in 400 litres of water |
| Decant of subsoil | 40 kg in 200 litres of | and applied in all beds |
| | water | |
| Wheat flour | 4 kg | |

F. composition F; at 50 DAS; This contains:RPI starts after this

| | | |
|---|---|---|
| Decant of subsoil | 50 kg in 200 litres | Mixed all components |
| | of water | in 2000 litres of water |
| Carrots boiled and | 25 kg | and applied in all beds |
| mashed | | |
| Tomato raw and ground | 20 kg | |
| Maize flour | 25 kg | |

G. composition G; at 56 DAS; This contains

| Decant of subsoil* | 25 kg in 200 litres of | | Mixed all components |
|---|---|---|---|
| | water | | in 2000 litres of water |
| Dried Sweet potato | 5 | kg | and applied in all beds |
| powder | | | |
| Dried carrot powder | 2.5 | kg | |
| Maize Flour | 12 | kg | |

H. composition H; at 61 DAS; This contains

| Decant of subsoil | 25 kg in 200 litres of | | Mixed all components |
|---|---|---|---|
| | water | | in 2000 litres of water |
| Dried Sweet potato | 2.5 | kg | and applied in all beds |
| powder | | | |
| Dried carrot powder | 5 | kg | |
| Yellow soy flour | 10 | kg | |

I. composition I; at 67 DAS; This contains

| | | |
|---|---|---|
| Rock dust | 25 kg in 200 litres of | Mixed all components |
| | water | in 2000 litres of water |
| Boiled and mashed | 15 kg | and applied in all beds |
| Sweet potato | | |
| Maize flour | 10 kg | |

J. composition J: at 72 DAS; This contains

| | | |
|---|---|---|
| Natural Unrefined | 20 kg in 200 litres of | Mixed all components |
| gypsum | water | in 2000 litres of water |
| Uncooked, ground | 40 kg | and applied in all beds |
| Tomatoes | | |

K. composition K; at 74 DAS; This contains

| | | |
|---|---|---|
| Rockdust | 50 kg in 200 litres of | Mixed all components |
| | water | in 2000 litres of water |
| Top soil | 50 kg in 200 litres of | and applied in all beds |
| | water | |
| Sub soil | 50 kg in 200 litres of | |
| | water | |
| Maize flour | 10 kg | |

L. composition L; at 77 DAS; This contains

| | | |
|---|---|---|
| Boiled and mashed | 20 kg | Mixed all components |
| carrots | | in 2000 litres of water |
| Boiled and mashed | 20 kg | and applied in all beds |
| sweet potato | | |
| Sub soil | 25 kg in 200 litres of | |
| | water | |

M. composition M; at 79 DAS; This contains

| | | |
|---|---|---|
| Boiled and mashed | 20 kg | Mixed all components |
| carrots | | in 2000 litres of water |
| Boiled and mashed | 20 kg | and applied in all beds |
| sweet potato | | |
| Sub soil | 25 kg in 200 litres of | |
| | water | |

N. composition N; at 86 DAS; This contains

| | | |
|---|---|---|
| Boiled and mashed | 30 kg | Mixed all components |
| carrots | | in 2000 litres of water |
| Boiled and mashed | 25 kg | and applied in all beds |
| sweet potato | | |
| Sour Curd (yoghurt) | 15 kg | |
| Sub soil | 25 kg in 200 litres of | |
| | water | |

O. composition 0; at 86 DAS; This contains

| | | |
|---|---|---|
| Boiled and mashed | 25 kg | Mixed all components |
| carrots | | in 2000 litres of water |
| Boiled and mashed | 25 kg | and applied in all beds |
| sweet potato | | |
| Boiled and mashed | 5 kg | |
| beetroot | | |
| Sub soil | 25 kg in 200 litres of | |
| | water | |

Vitamin D3 content was measured for control and treated samples. Vitamin D3 content was measured by Vimta Laboratories, Hyderabad, India. by HPLC, as IU/100 g. The result was 1606.59 IU/100 g, for the above experiment with wheat crop in 2018-2019. The control test was done with an independent commercially available wheat flour sample, of the same variety as the treated plot (Khudrat variety), it was found to be 0.0 IU.

### Example 2: Treatment of Wheat to Enhance Vitamin D Content, Season 2 (2019-2020)

Preparation of Plot

Crop: Wheat; location 2

Season: Rabi (November to March) started on 9^{th} dec 2019

i. Plot/Bed Preparation: area 2200 sq metres

Seed preparation was done as follows. Seeds of wheat variety (ankur) was soaked overnight in a specially prepared mixture. Mixture contains dried Sweet potato powder (100 g)+Carrot powder (100 g) in 200 litres of water. Stirred mixture and soaked wheat seeds (20 kgs) 10-12 hours or overnight. Suitable controls in water soaking also maintained.

For control plot, the control seeds were soaked in only water. Sowing was done two days after soaking the seeds. Direct sowing was done by manual sprinkling of the seeds on beds. 600 litres of 5 kg subsoil per 200 litres water was sprayed to both control and treated plots. Before sowing, 70 kg castor cake was applied manually.

Rest of the protocol for ploughing, bed preparation were the same as described in example. The treatment for wheat plants to increase nutrient content was done as per the following regimen:

A. composition A; at 18 DAS (; This contains (200 litres/barrel, 2 barrels for total plot)

| | | |
|---|---|---|
| Decant of Sub Soil | 15 kg in 200 | Total volume was |
| | litres of water | 400 litres |

| | | |
|---|---|---|
| Wheat flour | 4 | kg |
| jaggery | 4 | kg |
| Top soil | 30 | kg |
| Cow milk | 4 | litres |

B. composition B; at 30 DAS

| | Treated (Mixed all in | |
|---|---|---|
| | 1000 litres of water | Control -600 litres |
| | and applied in all beds) | was sprayed |
| Carrot extract | 10 kg | — |
| Decant of Sub soil | 25 kg | 15 kg in 600 litres |
| Sweet potato | 10 kg | — |
| tomato extract | 10 kg | — |

C. composition C; at 36DAS;

| | | |
|---|---|---|
| | Treated (Mixed all | |
| | components in 1000 | |
| | litres of water and | Control -600 litres |
| Extracts | applied in all beds) | was sprayed |

| | | | |
|---|---|---|---|
| carrots | 10 | Kg | |
| sweet potato | 10 | kg | |
| maize flour | 12.5 | kg | |
| subsoil | 25 | kg | 15 kg |

D. composition D; at 38 DAS; This contains

| | | |
|---|---|---|
| | Treated (Mixed all | |
| | components in 1000 | |
| | litres of water and | Control -600 litres |
| Extracts | applied in all beds) | of water |

| | | | |
|---|---|---|---|
| carrots | 10 | Kg | |
| sweet potato | 10 | kg | |
| maize flour | 12.5 | kg | |
| subsoil | 25 | kg | 15 kg |

E. composition E; at 52 DAS; This contains,

| | Treated- in 1000 litres | Control- 600 litres |
|---|---|---|
| | which was sprayed | which was sprayed |
| subsoil | 25 kg | 30 kg |
| rockdust | 25 kg | 15 kg |
| Maize flour | 10 kg | — |
| Castor cake | | 70 kg applied |
| | | manually |

F. composition F; at 54 DAS; This contains

| | Treated in 1000 litres | |
|---|---|---|
| | which was sprayed | Control- 600 litres |
| subsoil | 25 kg | 15 kg |
| Rock dust | 25 kg | 15 kg |
| Maize flour | 10 kg | — |

G. composition G; at 56 DAS; This contains

| | Treated in 1000 litres | |
|---|---|---|
| | which was sprayed | Control - 600 litres |
| subsoil | 25 kg | 15 kg |
| Maize flour | 10 kg | |
| Rock dust | 25 kg | 15 kg |

H. composition H; at 58 DAS; This contains

| | Treated in 1000 litres | |
|---|---|---|
| | which was sprayed | Control - 600 litres |
| subsoil | 25 kg | 15 kg |
| Rock dust | 25 kg | 15 kg |
| Maize flour | 10 kg | |

I. composition I; at 62 DAS; This contains

| | Treated in 1000 litres | Control - in 600 litres |
|---|---|---|
| | which was sprayed | of water |
| Sub soil | 25 kg | 15 kg |
| Rock dust | 25 kg | 15 kg |
| Top soil | 25 kg | |

J. composition J: at 64 DAS

| | Treated in 1000 litres | Control in 600 litres |
|---|---|---|
| | which was sprayed | of water |
| subsoil | 25 kg | 15 kg |
| T .soil | 25 kg | 15 kg |
| Rock dust | 25 kg | |
| Carrot juice | 10 kg | |
| Sweet potato juice | 10 kg | |

K. composition K; at 65 DAS; This contains

| | Treated in 1000 litres | Control in 600 litres |
|---|---|---|
| | which was sprayed | of water |
| Sub soil | 25 kg | 5 kg |

L. composition L; at 66 DAS This contains

| | Treated in 1000 litres | Control in 600 litres |
|---|---|---|
| | which was sprayed | of water |
| Sub soil | 25 kg | 5 kg |
| Carrot extract | 10 kg | — |
| sweet Potatoes extract | 10 kg | — |

M. composition M;

| | Treated in 500 litres | Control in 600 litres |
|---|---|---|
| | which was sprayed | of water |
| Sub soil | 12.5 kg | 15 kg |

N. composition N; at 68 DAS This contains

| | Treated in 500 litres | Control in 600 litres |
|---|---|---|
| | which was sprayed | of water |
| Sub soil | 12.5 kg | 15 kg |
| rockdust | 12.5 kg | 15 kg |

O. composition 0; at 69 DAS; This contains

| | Treated in 1000 litres | Control in 600 litres |
|---|---|---|
| | which was sprayed | of water |
| Carrot extract | 10 kg | — |
| Sweet potato extract | 10 kg | — |
| sub soil | 10 kg | 15 kg |

P. Composition P: 74 DAS

| | Treated in 1000 litres | Control in 600 litres of |
|---|---|---|
| | which was sprayed | water |
| subsoil | 25 kg | 15 kg |
| Carrot extract | 10 kg | |
| Sweet potato | 10 kg | |

Yield and Vitamin D3 content was measured for control and treated samples.

Yield was measured as given below. Four samples were collected from one square metre area each, which were from different areas of the plot. The plants were harvested, grains were threshed, dried, weighed. Average of the four different square metre areas was taken.

The four control values for yield per square metre were 395 g, 375 g, 435 g and 415 g. The average yield was calculated for the plot from these values to be 4.05 tons/hectare.

The four values for yield per square metre from the control plot were 390 g, 405 g, 422 g and 410 g. Final weight for wheat in the treated plot for the 2019-2020 year was 4.68 tons per hectare. Thus a percentage increase of 15% in yield was observed after treatment with the composition described herein.

Vitamin D3 content was measured by HPLC, as units/100 g, in Vimta labs, Hyderabad, India with their SOP. Vitamin D3 could not be detected in wheat crop from control plot. The Vitamin D3 result was 1803.97 IU/100 g, for flour derived from wheat crop from treated plot.

### Example 3: Nutrient Enhancing Composition, Formulation And Treatment For Rice (Rabi Season)

2019 Rabi: 245 square metre; Location: location 2

Season: Rabi (Jan to May 2019)

Seed preparation:27/1/2019 Seeds of paddy variety (Gangotri variety) was soaked overnight in a specially prepared mixture. Mixture contains dried 50 grams maize flour, and 50 g soy flour in 5 litres of water. Stirred mixture and soaked paddy seeds (overnight). Suitable controls in water soaking also maintained.

Direct sowing by manual sprinkling of the seeds on beds: sowing date was 1st Feb 2019. Transplantation was done at 31 DAS.

A. 39 DAS:

Application of following composition to the soil composition A;

| | | | |
|---|---|---|---|
| Brown rice | 2 | kg | Mixed all three |
| jaggery | 2 | kg | components in 200 |
| Coconut powder | 200 | g | litres of water and |
| ground | | | applied in all beds |
| All cooked and | | | |
| ground | | | |
| subsoil | 5 | kg | |
| Rock dust | 5 | kg | |
| Brown rice | 2 | kg | |

B. composition B; at 48 DAS; This contains

| | | |
|---|---|---|
| s-soil | 10 kg | Mixed all three |
| Rock dust | 10 kg | components in 200 |
| Top soil | 10 kg | litres of water and |
| | | applied in all beds |
| Bone meal | 20 kg | |
| Castor cake | 10 kg grinded and | |
| | sprinkled by hand | |

C. composition C; 68 DAS; This contains

| | | |
|---|---|---|
| carrots | 10 kg | Mixed all cooked and |
| beetroot | 10 kg | blended components in |
| Sweet potatoes | 10 kg | 200 litres of water and |
| | | sprayed through RPI |

The above composition was applied through RPI from flowering stage to seed set completion.

D. composition D; 94 DAS, which was seed set stage.

| | | |
|---|---|---|
| subsoil* | 30 kg in 200 | Mixed all components |
| | litres of water | in and applied in all |
| carrot extract | 2 Kg | beds |

At 96, 97 and 98 DAS, when seed set had completed, subsoil decant (30 kg in 200 litres water) was sprayed.

E. composition E; Applied at 114 DAS; This contains

| | | |
|---|---|---|
| coconut powder | 2 kg | Mixed all components |
| Decant of subsoil | 30 kg in 200 | in 200 litres of water |
| | litres of water | and applied in all beds |

Vitamin D3 was measured in rice flour from the above treated rice plants, at 3.4 MCG/100 g, which is 136 IU/100 g of rice flour.

### Example 4: Nutrient Enhancing Composition, Formulation And Treatment For Rice

2019 kharif paddy: 1 acre area total area half acre control. half acre treated. Location 1

Crop: Paddy; Season: Kharif (June to November 2019)

i. Seed preparation

Seeds of paddy variety (kaveri chintu variety) was soaked overnight in a specially prepared mixture for treated plot

| | |
|---|---|
| Treated 20 kg seed | Control -10 kg seed |
| 50 grams sweet potatoes powder | Water -15 litres of water |
| 50 g carrots powder | |
| 20 g tomatoes powder | |

in 15 litres of water. Stirred mixture and soaked paddy seeds (overnight). Suitable controls in water soaking also maintained.

ii. Sowing: 3^{rd} July

Direct sowing by manual sprinkling of the seeds on beds. Transplantation was done on 2^{nd} August, 30 DAS (days after sowing), 70 kg of castor cake, 70 kg of subsoil decant and 80 kg of coconut cake mixed in 200 litres of water was applied to the soil while transplantation, for both control and treated plots.

iii. Application of castor cake and subsoil decant was done at 48 DAS for both control and treated plots.

Preflower emerging was observed at 90 DAS

Sub soil plus top soil was applied 90 DAS and 97 DAS (at time of preflower emerging)

A. composition A; 108 DAS

| | Treated plot: Mixed all | | |
|---|---|---|---|
| | components in 3000 | | |
| | litres of water and | | Control plot- 1500 |
| | applied in all beds | | litres of water |
| Decant of Sub Soil | 150 | kgs | 75 kgs |
| Carrot extract/powder | 30 | kgs | — |
| Sweet potato | 15 | kgs | — |
| Beet root | 30 | kg | — |

B. composition B; at 111 DAS; This contains

| | Treated plot: Mixed all | | Control plot: Mixed all |
|---|---|---|---|
| | components in 3000 | | components in 1500 |
| | litres of water | | litres of water |
| Decant of Sub Soil | 150 | kgs | 75 kgs |
| Carrot extract/powder | 30 | kgs | — |
| Sweet potato | 15 | kgs | — |
| Beet root | 30 | kg | — |

C. composition C; at 114 DAS, This contains

| | Treated plot: Mixed all | | Control plot: Mixed |
|---|---|---|---|
| | components in 3000 | | all components in |
| | litres of water | | 1500 litres of water |
| Decant of Sub Soil | 150 | kg | 75 kg |
| Sweet potato extract | 45 | kg | — |
| Tomato extract | 30 | kg | — |
| Maize flour | 30 | kg | — |

D. composition D; Applied by rain pipe irrigation at 118 DAS, This contains

| | |
|---|---|
| Treated plot: Mixed all | Control plot: Mixed all |
| components in 3000 | components in 1500 |
| litres of water | litres of water |

| | | | | |
|---|---|---|---|---|
| subsoil | 300 | kgs | 175 | kgs |
| rockdust | 75 | Kgs | 39.5 | Kgs |

| | | | |
|---|---|---|---|
| Maize flour | 30 | kgs | — |

E. composition E at 120 DAS; This contains

| | Treated plot: Mixed all | | Control plot: Mixed all |
|---|---|---|---|
| | components in 3000 | | components in 1500 |
| | litres of water | | litres of water |
| Sweet potato extract | 30 | kg | — |
| Decant of subsoil | 300 | kgs | 143.5 kg |
| rockdust | 75 | kgs | — |
| Cow milk | 30 | litres | — |
| Gypsum | | | 37.5 kg |

F. composition F; at 122 DAS This contains

| | Treated plot: Mixed all | | Control plot: Mixed all | |
|---|---|---|---|---|
| | components in 3000 | | components in 1500 | |
| | litres of water | | litres of water | |
| Decant of subsoil* | 150 | kg | 75 | kgs |
| Carrots extract | 30 | kg | | |
| Sweet potato | 30 | kgs | | |
| Maize flour | 3.75 | gms | | |
| Rock dust | 75 | kgs | | |
| Gypsum | | | 37.5 | kg |

G. composition G; Applied through rain pipe irrigation at 127 DAS, This contains:

(Harvesting was done at 145 DAS)

| | Treated plot: Mixed all | | Control plot: Mixed all | |
|---|---|---|---|---|
| | components in 3000 | | components in 200 | |
| | litres of water and | | litres of water and | |
| | applied in all beds | | applied in all beds | |
| Decant of subsoil | 150 | kg | 75 | kg |
| Carrots extract | 37.5 | kg | — | |
| Sweet potato | 37.5 | kg | — | |
| Rock dust | 75 | kg | 37.55 | kg |

| | | | |
|---|---|---|---|
| Gypsum | — | 37.5 | kg |

Yield and Vitamin D3 content was measured for control and treated samples. Yield was measured as given below. Four samples were collected from one sq metre area ach, which were from different areas of the plot. The plants were harvested, grains were threshed, dried, weighed. Average of the four different square metre areas was taken.

The four control values for yield per square metre were 915 g, 890 g, 880 g and 940 g. Final average weight for rice in the control plot was 2019 kharif season experiment was 9.06 tons/hectare. The four values for yield per square metre from the treated plot were 980 g, 952 g, 990 g and 950 g. Final average weight for rice in the treated plot for the 2019 kharif season experiment was 9.68 tons/hectare. Percentage yield increase was 7%.

Vitamin D3 content was measured by HPLC, as units/100 g. Vitamin D3 was not detected in the sample taken from the control plot. The result for Vitamin D3 in wheat flour made from rice sample in treated plot was 102.70 IU/100 mg, for rice crop in 2019 kharif season.

TABLE 1
Summary of Vitamin D and yield values from experiments in
wheat and rice over two seasons and in two locations.

| | | | | | Vit D3 of |
|---|---|---|---|---|---|
| | | | Yield of | Vitamin | treated |
| | | yield in | treated | D3 in | sample (IU) |
| Crop | year | control | sample | control | per 100 g |
| wheat | 2018-2019 | Not | Not | 0.0 | 1606.59 |
| | | measured | measured | | |
| wheat | 2019-2020 | 4.05 tons/ha | 4.68 tons/ha | Not | 1803.97 |
| | | | | detected | |
| rice | 2019 rabi | Not | Not | | 136 |
| | | measured | measured | | |
| Rice | 2019 kharif | 9.06 tons/ha | 9.68 tons/ha | Not | 102.70 |
| | | | | detected | |

We claim:

1. A nutrient enhancing composition comprising carrot extract, maize flour and sweet potato extract, wherein the composition increases vitamin D content in crop plants when applied during irrigation of crop plants.

2. The composition of claim 1, wherein the carrot extract, sweet potato extract and maize flour are present at a concentration of 2 to 5 kg per 200 litres of irrigation water.

3. The composition of claim 1, wherein the carrot extract and sweet potato extract are made by cooking and blending raw carrots and sweet potatoes respectively at a weight that is half of the final extract weight required.

4. The composition of claim 1, wherein it further comprises beet root extract.

5. The composition of claim 1, wherein it is applied to the crop plants at least once between flowering and harvest.

6. The composition of claim 5, wherein it is applied to the crop plants at least twice between flowering and harvest.

7. The composition of claim 5, wherein it is applied at least once before flowering time.

8. The composition of claim 1, wherein it is applied during irrigation by spray irrigation.

9. The composition of claim 1, wherein its application also increases yield of crop plants.

10. A method of increasing Vitamin D content in crop plants, wherein the method comprises the step of applying at least once a nutrient enhancing composition comprising carrot extract, maize flour and sweet potato extract during irrigation of the crop plants.

11. The method of claim 10, wherein the carrot extract, sweet potato extract and maize flour are present at a concentration of 2 to 5 kg per 200 litres of irrigation water.

12. The method of claim 10, wherein the at least one application is done between flowering time and harvest of crop plants.

13. The method of claim 10, wherein it further comprises at least one application of the composition before flowering.

14. The method of claim 10, wherein it further comprises soaking the seeds of the crop plant in the composition before sowing.

15. The crop plants produced by the method of claim 11.

16. The grains of the crop plants produced by the method of claim 11
